(19) United States
(12) Patent Application Publication
(10) Pub. No.: US 2012/0169822 A1
(43) Pub. Date: Jul. 5, 2012

(54) Information Recording System and Information Recording Method

(76) Inventor: Dong Chen, GuangDong (CN)

(21) Appl. No.: 13/496,688

(22) PCT Filed: Sep. 17, 2010
(86) PCT No.: PCT/CN2010/077079

§ 371 Date: Mar. 16, 2012

(30) Foreign Application Priority Data
Sep. 18, 2009 (CN) 200910190100.4

(51) Int. Cl. B41J 2/00

(52) U.S. Cl. 347/110

(57) ABSTRACT

An information recording system is provided. The information recording system comprises: a recording unit (5) for recording corresponding information on a recording medium (15); a medium information unit (3) for acquiring and/or modifying medium-condition information about the recording medium; a feeding unit (4) for feeding the recording medium through the medium information unit and the recording unit in turn; and a control unit (1) for controlling the operation of each part of the information recording system. A reusable recording medium can be reused many times in the information recording system. When the reusable recording medium is mixed with a non-reusable recording medium, the information recording system can distinguish between them, and then perform the subsequent processing operation. An information recording method is also provided.

### BACKGROUND OF THE INVENTION

1. Technical Field

The invention relates to an information recording system and an information recording method.

2. Description of Related Art

At present, the information recording system has been widely applied in the automatic office environment. For example, a printer, copier, fax or combination machine can transfer data information onto portable recording media for reading, such as printing paper, copying paper or photo printing paper.

However, the existing information recording system basically has no media detecting mechanism, which means that different recording media are processed in the same way, which is outdated.

In most cases, the existing information recording system uses the disposal of paper which is useless after use. In the prior art, there are some kinds of recyclable papers, for example, a special device for heating and erasing recyclable thermo-sensitive recording media disclosed in the patent application No. 200710149052.5 and a special magnetic printer for magnetic materials disclosed in the patent application No. 03119408.7 which displays/cancels writings via the vertical movement of the magnetic materials in the magnetic paper displayer in the magnetic field to realize the repeated use of the magnetic display paper. Unfortunately, the two devices have no media detecting mechanism.

The nature of printing is the conversion and storage processes of data, which converts data into characters capable of being recognized by human eyes and then writes (or prints) the characters onto a media page, therefore existing printers are substantially an information recording and processing system.

### BRIEF SUMMARY OF THE INVENTION

The technical problem to be solved in this invention is to provide a system and a method for automatically recording and processing different recording media to overcome the defects in the mentioned processing system,

in particular to provide a system and a method for automatically and repeatedly recording information on recyclable recording media.

The invention first provides an information recording method, comprising a step (U1) of detecting the information state from the input recording media and a step (U2) of deciding which operation to apply according to the information state of the recording media.

Thus, a media information unit is provided for detecting the information state of the recording media in the following way:

Detect the state information of the media with an identification cord detecting processor according to the information state of the media page. In this way, the media page is provided with an identification code for identifying the information state of the media, the identification code stores the media attributes and related information state, and may be used as a first mark for identifying whether or not the recording media is used, and/or a second mark for identifying whether or not the recording media can be repeatedly used, and/or a third mark for identifying the type of recording media, and/or a fourth mark for identifying the recording means of the recording media; in actual use, there are more applications, which comprise but are not limited to the method mentioned.

Of course, the information state of the media can be not only directly adhered to the recording media in the formats of magnetic bar, graphic code, etc, but also transferred into different recording media via different media feeding boxes. For example, recyclable recording media with the same properties which are required to be used repeatedly are placed in the same media feeding box; while new recording media, which can be printed without special pre-treatment, can be replaced in another media feeding box. Thus, the media information unit can smoothly acquire the information state of the recording media just by acquiring the source of the recording media.

The media's information state which is capable of being identified according to the media feeding route can be classified into the following types: first state information for identifying whether or not the recording media is used, and/or second state information for identifying whether or not the recording media can be repeatedly used, and/or third state information for identifying the type of the recording media, and/or fourth state information for identifying the recording means of the recording media; in actual use, there are more applications, which comprise but are not limited to the method mentioned.

Thus, the system for recording information can process the media in different ways according to the information attributes of the media, to improve the pertinence, efficiency, and scientific nature of the treatment.

The invention provides an information recording system, comprising a recording unit for recording the contents on the media;

a media information unit for detecting and/or correcting the related state information of the recording media and deciding the concrete treatment procedure according to the detection result of the media's state information;

a feeding unit for transferring the recording media to the media information unit and the recording unit; and a

control unit for controlling the feeding unit, media information unit and recording unit respectively.

Correspondingly, the invention also provides a method for recording information, comprising:

a step for feeding the media: the recording media is input from the feeding unit;

A step of processing the media information: the media information unit reads and/or writes the corresponding information state of the recording media;

a recording step: the printing unit under the control of the control unit records the corresponding contents on the recording media according to the media information state.

By adopting the mentioned technical solution, the information recording system can perform corresponding printing treatment on different printing media or according to different printing requirements. For example, for photo papers and common papers, the information recording system can perform different printing operations to obtain desirable output effects.

In one preferable embodiment of this invention, the recording unit comprises at least two different recording processing modules; the control unit chooses one of the two modules to process the corresponding recording media,

wherein, the recording processing module may be a laser print head, an ink-jet print head, etc., therefore the control unit can select different recording processing modules to carry out the corresponding printing operation according to the order input by a user or the acquired media information state.

In one preferable embodiment of this invention, the information recording system is applicable to reusable recording media. The information recording system also comprises: a media processing unit for processing the recording media according to the media state information acquired by the media information unit; the feeding unit passes on the recording media to the media information unit, the media processing unit and the printing unit in turn.

Correspondingly, the information recording method also comprises a media processing step between the media information processing step and the recording step, wherein the media processing unit correspondingly processes the recording unit according to the media state information acquired by the media information unit; the media state information comprises the properties of the recording media, information about whether or not the recording media is used, etc. The recording media by be reusable or non-reusable. When recording media which is incapable of being used repeatedly is adopted, the media information state usually is null. Accordingly, the media information unit also can judge the input recording media.

In comparison with the prior art, the mentioned embodiment further comprises the advantage that the recyclable recording media can be automatically recycled many times in the information recording system disclosed in this invention; and, when the reusable recording media has non-reusable recording media, the two types of recording media are differentiated and then the subsequent recording and processing operations are carried out.

Furthermore, the media information unit may be a magnetic read-write device, a graphic code detector, or both.

Of course, the media information unit may also comprise a route detector for detecting the source of the recording media. Therefore, the recyclable recording media with the same properties which are required to be used repeatedly are placed in the same medium feeding box; while the new recording media, which can be printed without special pre-treatment, can be replaced in another medium feeding box. Different media feeding boxes are different routes of the recording media sources.

In one embodiment of this invention, the media processing unit comprises an erasing device for erasing the contents existing on the recording media.

Furthermore, the erasing device may be a chemical, magnetic or thermo-sensitive erasing device.

In one embodiment of this invention, the media processing unit comprises a levelling device for levelling the recording media.

### BRIEF DESCRIPTION OF THE SEVERAL VIEWS OF THE DRAWINGS

FIG. 1 is a flow chart of the information recording method in the embodiment of this invention;

FIG. 2 is a structural view of one embodiment of the information recording system of this invention;

FIG. 3 is a structural view of another embodiment of the information recording system of this invention;

FIG. 4 is a front view of a page recording media;

FIG. 5 is a data structural diagram of the identification code of the page recording media in FIG. 4.

FIG. 6 is a basic laminated structural view of the page recording media of the page recording media in FIG. 4 under the microscope;

FIG. 7 is a schematic view of processing the media information unit with a detecting processor according to the media state information;

FIG. 8 is a schematic view of processing the media information unit according to the result of the media feeding route detection;

FIG. 9 is a flow chart of the basic treatment on the page media;

FIG. 10 is a view of the configuration box of the reusable page media recording system;

FIG. 11 is a view of the basic hardware configuration of the page media treatment;

FIG. 12 is an operation flow chart of the system;

FIG. 13 is a laminated structural view of the reusable page media under the microscope;

FIG. 14 is a view (front view) of the erasing device of the page media in FIG. 13;

FIG. 15 is a view (lateral perspective view) of the erasing device of the page media in FIG. 13;

FIG. 16 is a structural view of the liquid conduit of the erasing device of the page media in FIG. 14;

FIG. 17 is a view (front view) of the levelling device of the page media in FIG. 13;

FIG. 18 is a view (lateral perspective view) of the levelling device of the page media in FIG. 13;

FIG. 19 is a view of the component of the reusable page media under the microscope;

FIG. 20 is a structural view of the component of the reusable page media under the microscope;

FIG. 21 is a data structural diagram of the identification code of the page media;

FIG. 22 is a view of the systematic configuration box of the processing system of the page media in FIG. 21;

FIG. 23 and FIG. 24 are data structural diagrams of the identification codes of two kinds of page media;

FIG. 25 is a view of the systematic configuration box of the processing system of the page media in FIG. 23 and FIG. 24;

FIG. 26 is a lateral perspective view of a systematic drive mechanism that identifies the media state information according to the media feeding route;

FIG. 27 is a schematic view of the internal structure of a mobile drive unit in FIG. 26.

### DETAILED DESCRIPTION OF THE INVENTION

The system is introduced briefly by means of the attached drawings and then further described in detail with some embodiments.

FIG. 1 is the flow chart of the information recording method. The method comprises the following steps of: U1) detecting the information state of the input recording media; U2) deciding the operation according to the information state of the recording media.

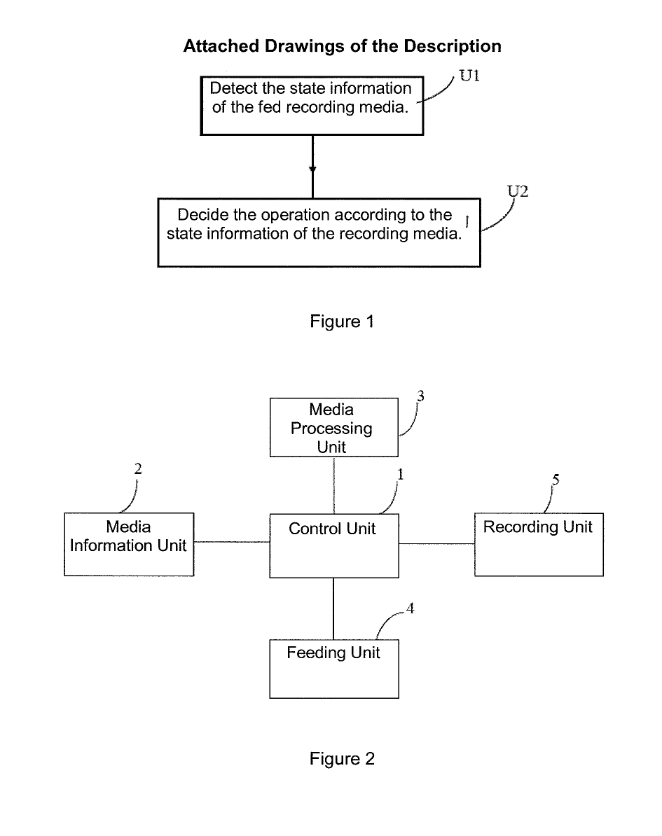

The structural views of two kinds of two embodiments are described below. As shown in FIG. 2 an information recording system comprises: a recording unit 5 for recording corresponding contents on the recording media; a media information unit 2 for acquiring and/or correcting the related state information of the recording media; a media processing unit 3 for processing the recording media correspondingly according to the state information acquired by the media information unit; a feeding unit 5 for passing on the recording media to the media information unit 2, the media processing unit 3 and the recording unit 5 in turn; and a control unit 1 for respectively controlling the recording unit 5, the media processing unit 3, the feeding unit 4 and the media information unit 2.

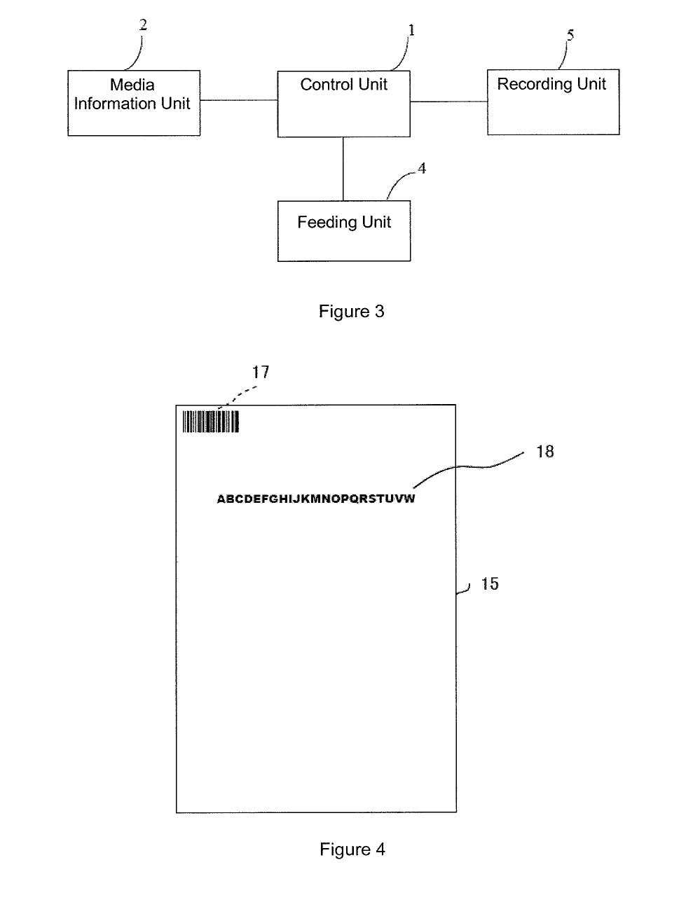

As shown in FIG. 3, an information recording system comprises: a feeding unit 4 for passing the recording media to the media information unit 2 and the recording unit 5 in turn; a media information unit 2 for acquiring and/or correcting the related information state of the recording media; a recording unit for processing the recording media differently according to the media state information acquired by the media information unit; and a control unit 1 for respectively controlling the recording unit 5, the feeding unit 4 and the media information unit 2.

The invention provides a method for identifying the information state on the recording media page. This method and the detection equipment used are described in the embodiment of the media information unit 2:

FIG. 4 is a front view of a page recording media 15; the mark 18 is the recorded information, and the state information identification code 17 is a magnetic bar or two-dimensional bar code for system identification.

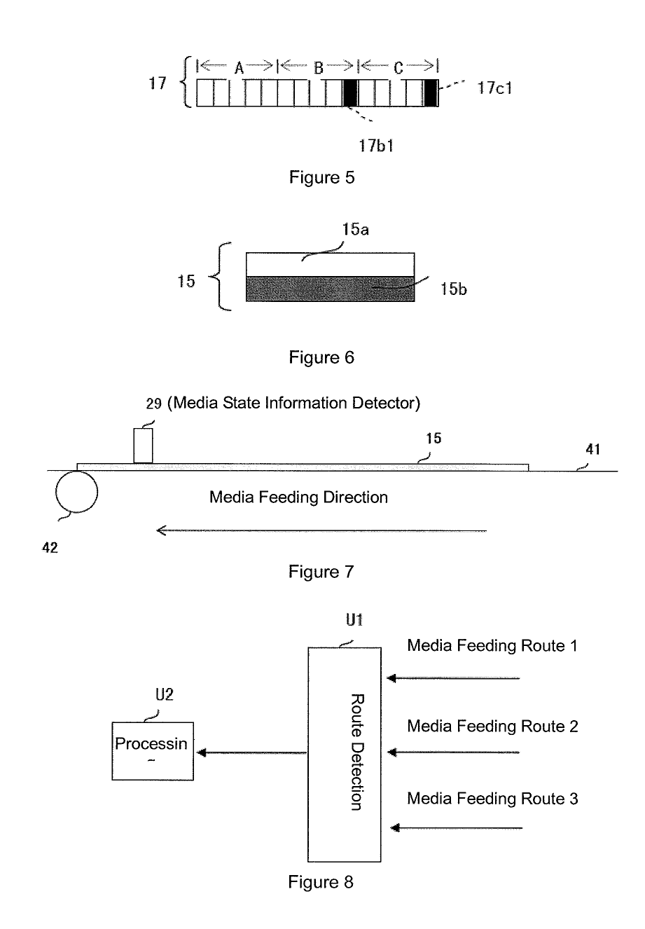

FIG. 5 is the date structural view of the identification code 17, namely the magnetic bar or the two-dimensional bar code. The identification code 17 uses the binary numeral for storage and expression, and the numeral structure thereof is at least divided into three data areas: A, B and C, wherein the area A is used for storing the information about the media properties (capable of being classified according to the recording treatment means, such as the thermo-sensitive print media, magnetic-sensitive print media, general print-laser/jet ink/needle media); the area B is used for storing the information about the media type (whether or not the media is recyclable, the printing features of the media itself: such as common printing paper and photo printing paper), and the area C is used for storing the information about the use state of the media (which means that whether or not the paper has been printed).

The identification code 17 of the media 15 may consist of the data information of the mark 17c1 and the mark 17b1, the data information of the mark 17b1 is the second mark representing that the media is reusable, and the data information of the mark 17c1 is the first mark representing the use state of the media.

As shown in FIG. 5, the method for representing the data of the mark 17b1 (the second mark) and the mark 17c1 (the first mark) of the page media 15 of the information carrier processing system using the media in a recycled way is described. The representation is comprised of, but not limited to this method.

If the data area of the media state mark 17b1 (the second mark) of the page media 15 has a mark (the binary value at the position 17b1 corresponding to the data area B is 1), this means the page media 15 is a reusable media, and the media state mark 17b1 (the second mark) is permanently fixed in the reusable page media 15 in the form of bar code or magnetic bar code, which is generated when the recording media is produced. If the data area of the media state mark 17b1 (the second mark) is blank (which means no mark exists, the binary value at the position 17b1 corresponding to the data area B is 0), this means that the page media 15 is a common media used in general conditions.

If the data area of the media state mark 17c1 (the first mark) of the page media 15 has a mark (the binary value at the position 17c1 corresponding to the data area C is 1), this means the page media 15 is a used media, and the media state mark 17c1 (the first mark) is the media state mark left by the system in the previous processing process. If the data area of the media state mark 17c1 (the first mark) is blank (which means no mark exists, the binary value at the position 17c1 corresponding to the data area C is 0), this means that the page media 15 is not used.

Methods for detecting two kinds of different state information of the media are introduced below.

As shown in FIG. 7, Detection of the state information of the media is completed with an identification cord detecting processor according to the state information of the page media. The page media 15 is fed by the feeding unit 4 via the feeding route 4′, the state information identification code 17 of the page media 15 and the media detection unit 29 compose the media information unit 2, the media detection unit 29 is a graphic code detector or a magnetic bar code read-write detector, thus, the media information unit 2 can detect the media state information.

As shown in FIG. 8, Detection of the state information of the media is completed by detecting the feeding route information of the page media. The media is fed via a feeding route 1, a feeding route 2 and a feeding route 3, the step U1-detecting the state information of the fed recording media is completed by route detection, and then the step U2-deciding the operations adopted according to the state information of the recording media is completed according to the detection result in step U1.

This invention is further described in details with the following preferable embodiments:

The printing machine is used as an example of the information recording system to give the description, and the principles of the duplicator, the fax, the scanner and other information recording system are the same as that of the printing machine, therefore, detailed description based on those systems are avoided.

### Embodiment 1

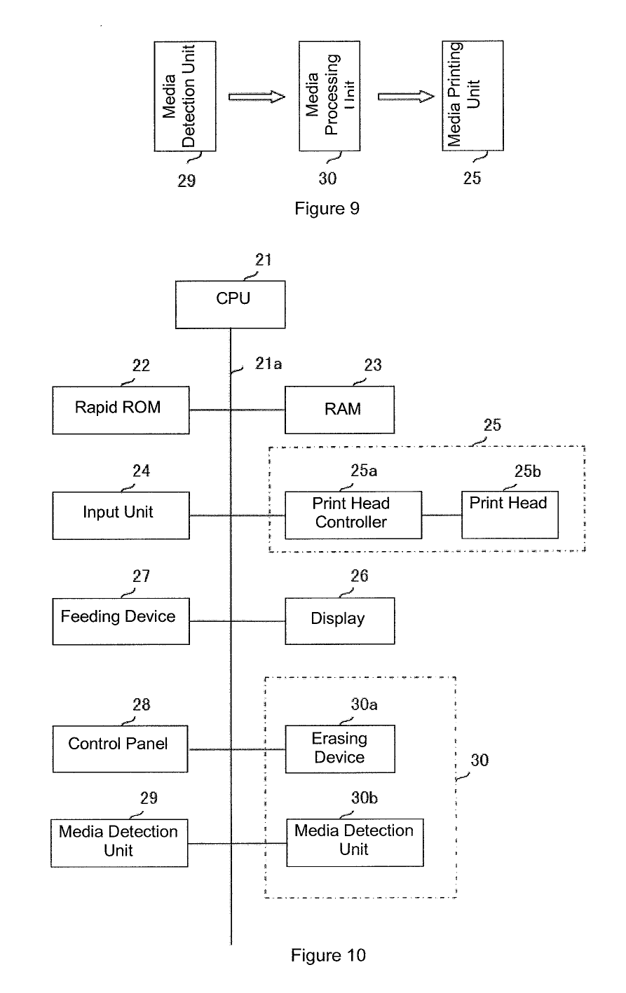

This is an example applied to the reusable page media recording system. First, refer to the flowchart of the FIG. 9 which illustrates the basic processing process of the reusable page media.

As shown in FIG. 9, a media detection unite 29 completes the basic detection of the media, including the detection on the type of the media, which means whether or not the media has the same properties (processed by the same print head), whether or not the media is reusable; and the detection on the use state of the media, which means whether or not the media is used. A media detection unit 29 completes the media detection according to the state information mark of the media 15 to make preparations for further media processing in the next step.

A media processing unit 30 is used for processing the used media, including the erasing and levelling operations.

A media printing media 25 is used for printing the data on the page media, including a print head controller and a print head.

The information recording method and the information recording system comprises: a step of feeding the media : the recording media is input from the feeding unit; a step of processing the media information: the media information unit detects and processes the state information of the recording media;

a step of processing the media: the media processing unit correspondingly processes recording media according to the media state information acquired by the media information unit.

a step of recording: the printing unit prints corresponding contents on the recording media processed in the previous step.

Next, refer to the systematic configuration figure of the reusable media in FIG. 10. As shown in FIG. 10, the mark 21 in the attached drawing represents the CPU (central processing unit) of the information carrier processing system using the media in a recycled way. A system bus 21a is connected to a rapid ROM22 (read-only memory) (flash ROM), a RAM 23 (random access memory), an input unit 24, a media printing unit 25, a display 26, a feeding unit 27, a control panel 28, a media detection unit 29 and a media processing unit 30 from the CUP of the mark 21.

The rapid ROM22 stores necessary control programs of the operation of the information carrier processing system as shown in FIG. 12.

The RAM 23 ensures the working area for different control programs.

The input unit 24 mainly completes the reading and input of the data, including transmission input of the data of the host system and the reading input of the data of the stored media.

The media writing-in media 25 is used for printing the data onto the page media, including a print head controller 25a and a print head 25b.

The print head controller 25a outputs a drive signal to the print head 25b which may be a needle head, an ink jet head, a laser printing mechanism, a thermal head, a magnetic head, a photosensitive printing mechanism which works according to the photosensitization of the media, or a static printing mechanism which works according to the static reaction of the media. The print head is not limited to the type mentioned.

The display 26 displays the operation information.

The feeding unit 27 comprising a stepping motor and a feeding roller for example is used for feeding the printing media 15.

The feeding unit 27 comprises components which are not limited to the type mentioned.

The control panel 28 completes corresponding operations by means of corresponding control keys.

The media detection unit 29 is used for detecting the printing state mark 17b1 (the second mark) and the printing state mark 17c1(the first mark) of the media 15 fed by the feeding device 27, comprising a magnetic bar code read or a bar code detector, but not limited to those mentioned.

The media processing unit 30 is used for processing the used media, comprising a media erasing device 30a and a media levelling device 30b. The erasing device 30a comprises, for example, an erasing mechanism using printing erasing liquid, a thermo-sensitive erasing mechanism, an erasing mechanism adopting the principle of the magnetic field, The erasing device 30a is used for erasing the old information 18 on the printing media 15 fed by the feeding device 27, including but not limited to the mentioned type.

The media levelling device 30b comprises, for example, a thermal press adopting the thermal press principle, to level the printing media 15 fed by the feeding device by pressure and certain heat, wherein the most important is that the strengthened glue coating 15b of the printing media 15 undergoes physical changes by means of certain heat and pressure to re-level the printing media 15. The media levelling device is not limited to the type mentioned.

Next, refer to FIG. 6 which shows the most basic laminated structure of the reusable page media 15 under an endoscope, which include but is not limited to the following types and structures.

An information recording layer 15a of the page media 15 is used for recording and storing information.

The strengthened glue coating 15b of the page media 15 comprises at least one of the following materials: thermoplastic high polymer, metal foil and nano-material which can be tightly adhered with the information recording layer 15a and be plastic and extensible under special temperature and pressure.

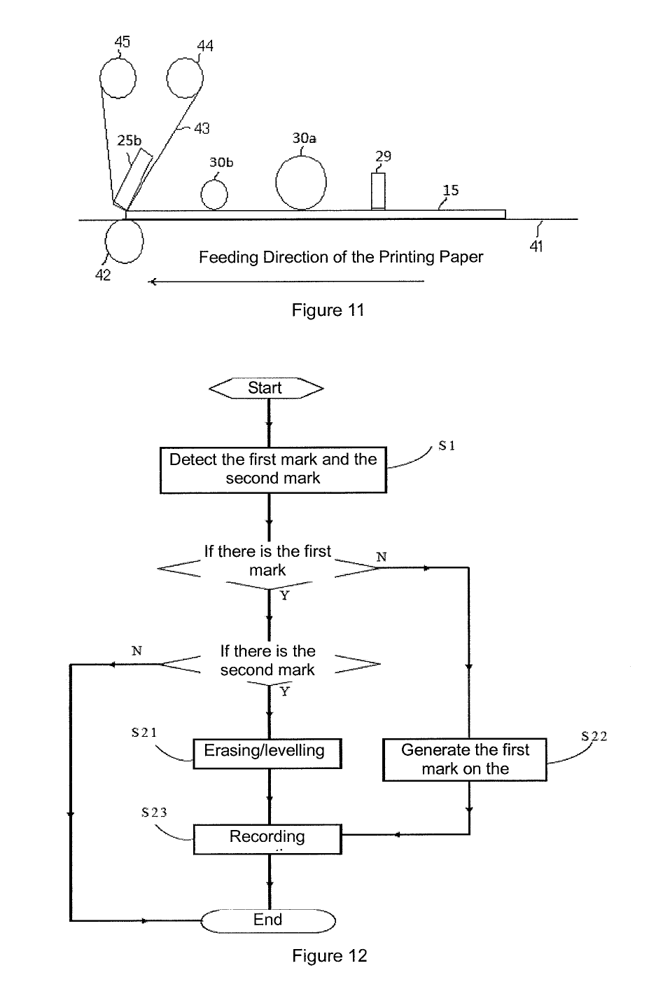

Refer to FIG. 11 which illustrates the basic part of the page media hardware configuration of the information carrier processing system using the media in a recycled way.

As shown in FIG. 11, the mark 41 in the attached drawing represents the feeding route of the page media 15. The page media 15 is fed by the feeding unit 27 via the feeding route 41.

The mark 42 in the attached drawing represents a paper press roller. The media detection device 29 is disposed on the upstream side opposite to the paper press roller.

The erasing device 30a is disposed on the lower stream side of the media detection device 29, wherein the feeding route 41 is located between the erasing device 30a and the paper press roller 42.

The media levelling device 30b is disposed on the lower stream side of the erasing device 30 (or the upstream side of the erasing device 30a according to the different features of the media), wherein the feeding route 41 is located between the levelling device 30b and the paper press roller 42.

The print head 25b is disposed adjacent to the feeding route 41 and opposite to the paper press roller 42.

A lateral roller 44 for feeding an ink belt 43 is disposed on the upstream of the print head 25b. A lateral roller 45 for roll an ink belt 43 is reeling the ink belt 43 is disposed on the lower stream of the print head 25b.

FIG. 11 shows the state when the printing media 15 arrives at the initial position of the print head 25b. The initial position is the position where the print head starts to print. The sequence that systematic marks 17b1 (the second mark) and 17c1 (the first mark) of the printing media in FIG. 5 pass through the feeding device 27 is detected by the media detection device 29. The printing media passes through the positions directly below the erasing device 30a and the media levelling device 30b in sequence.

Refer to the flowchart in FIG. 12 which illustrates the operations of the embodiment of the page media with the mentioned configuration.

When the recording data is input into a personal computer (not shown) via an input unit 24, the media 15 is fed by the feeding device 27 from the feeding route 41 and passes through the media detection device 29 in sequence, and the media detection device 29 detects the first and second marks of the media 15 (step S1).

A control device 22 performs the following treatment according to the results of the above mark detection of the media detection device 29:

if the first mark (17c1) and the second mark (17b1) are detected, which means the media 15 is a reusable media which has been printed, erase and level the media, erase the old contents 18 (step S21) and make records (step S23);

if only the second mark (17b1) is detected, which means the media 15 is a reusable media which is not printed, generate the first remark (17c1) on the recording media by the system (step S22) and make records (step S23);

Thus, the recording media having the first mark is used for recording the information, and when used again, whether or not the recording media is used by detecting the first mark; If the first mark is detected, this means the recording media is used; if not, this means the recording media is not used, wherein the first mark is a magnetic bar code which is detected by the magnetic means or a bar code detected by bar code detection means;

if the second mark (17b1) and the first mark (17c1) are not detected, which means the media 15 is a common media (printing paper) which is not printed, generate the first remark (17c1) on the recording media by the system (step S22) and make records (step S23);

if the second mark (17b1) is not detected, but the first mark (17c1) is detected, which means the media 15 is a common media (printing paper) which is printed, directly make the media 15 pass through the information recording system (the printing machine) by the feeding device 27, wherein no printing action is done.

The related descriptions of above-mentioned basic form and structure of the information recording system using the media in a recycled way are provided by combining the embodiment according to different application.

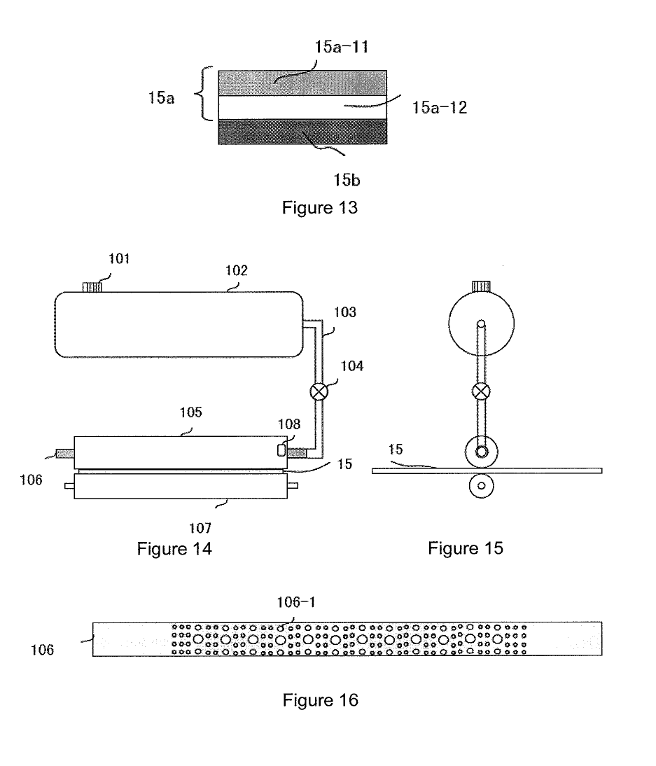

FIGS. 13, 14, 15, 16, 17 and 18 illustrate embodiments of processing the page media by the system.

FIG. 13 is a laminated structural view of the reusable page media 15 under the microscope;

The information recording layer 15a of the page media 15 is divided into two layers: a waterproof coating 15a-11 and a paper core 15a-12.

The waterproof coating 15a-11 is used for preventing the media 15 from humidification and deformation when the erasing device 30a erases the pointed information 18 with the erasing liquid.

The paper core 15a-12 is fibres (or other substrate) composing the media 15 for strengthening the toughness of the media.

The page media 15 adopts the magnetic bar code (or the bar code) to make the printing state marks 17b1(the second mark) and/or 17c1 (the first mark).

The principle of using recycling this page media is that: the media 15 is printed with characters (printing information 18) by needle printing, ink jet printing or laser printing, the printing information 18 on the information recording layer 15a of the page media 15 is erased by erasing liquid, thus, the page media can be used repeatedly.

As shown in FIG. 9 which illustrates the basic processing flowchart of the reusable page media and the FIG. 10 which illustrates the system configuration:

the media detection unit 29 is used for detecting and processing the printing state mark 17b1 (the second mark) and the printing state mark 17c1(the first mark) of the media 15 fed by the feeding device 27 by the magnetic bar code reader (or bar code detector, according to the media marking means).

The media 15 is a page media, so the media processing unit 30 comprises two parts: the media erasing device 30a and the media levelling device 30b.

FIGS. 14 and 15 are schematic views of the erasing device 30a of the media 15 (FIG. 14 is the front view and the FIG. 15 is the lateral perspective view), wherein the number 102 represents an erasing liquid container, 101 represents the bottle cover of the container, 103 represents a conduit, 108 represents a humidity detector for detecting the humidity on the washing roller; 104 represents an electromagnetic valve opened and closed by a control unit according to the numerical value detected by the humidity detector; 106 represents a liquid conduct with a liquid hole 106-1 as shown in the FIG. 16, wherein the liquid in the erasing liquid container permeates into the capillary fib on the washing roller 105 via the liquid hole; 107 represents the paper press roller, the page media 15 passes through between the washing roller 105 and the paper press roller 107, the erasing liquid on the washing roller and the substance for recording the printing information 18 on the media 15 react to erase the printing information 18, so the media can be used repeatedly.

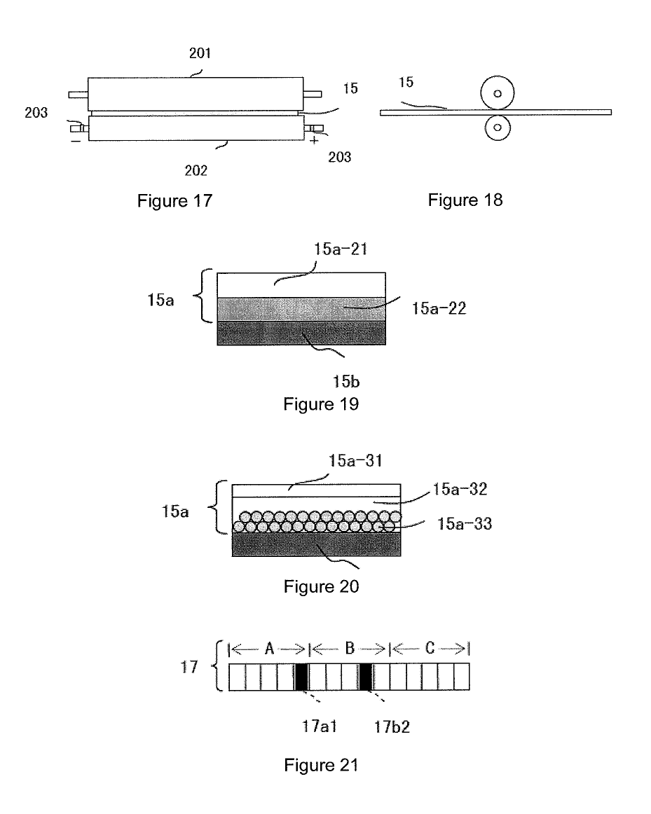

FIGS. 17 and 18 are schematic views of the levelling device 30b of the media 15 (FIG. 14 is the front view and the FIG. 15 is the lateral perspective view): 201 presents the paper press roller; 202 represents a thermal press roller with an electric heating component inside, wherein the electric heating component generates heat to make the thermal press roller at a certain temperature; 203 represents electrodes (positive and negative electrodes) on the thermal pressure roller; the page media 15 passes through between the paper pressure roller 201 and the thermal pressure roller 202 to make the strengthened glue coating 15b of the page media 15 undergo physical change under certain temperature and pressure, so the media is re-levelled.

The print head 25b prints information 18 on the media 15. The print head 25b may be a needle head, ink jet head or a laser printing mechanism.

FIG. 19 is an embodiment of processing another reusable page media 15 of which the information recording 15a is divided into two layers under endoscope: colourless dye 15a-21 and developer 15a-22.

The page media 15 adopts the magnetic bar code (or the bar code) to make the printing state marks 17b1(the second mark) and/or 17c1 (the first mark).

The principle of recycling this kind of media is that: when the page media (paper) is heated to a certain temperature (180° C.) by a special printing device, the developer 15a-22 is fused and mixed with the dye 15a-21, and then writings are printed on the surface of the page media (paper); the process is repeated, when the temperature changes (such as 100° C.)) the developer is separated from the dye and crystallized, and then the writings on the paper are erased.

The recording media has a levelling layer 15b which adopts the thermal press principle to level the media, so the erasing device and levelling device in the information recording system using this kind of recording media can be designed as one component.

FIG. 20 is an embodiment of processing another reusable page media. Under the endoscope, the information recording layer 15a of the page media 15 is divided into two layers: a transparent film layer 15a-31 and a developing layer which consists of a white lubricating agent 15a-32 and a soft magnetic materiall 15a-33.

The page media 15 adopts the magnetic bar code (or the bar code) to make the printing state marks 17b1 (the second mark) and/or 17c1 (the first mark).

The principle for recycling this kind of media is that: when the page media 15 passes through the special printing machine equipped with a magnetic needle, the soft magnetic materiall 15a-33 of the media 15 rises to a position below the transparent film layer 15a-31 under the action of the magnetic force to print the characters on the media. Likely, the principle that a magnet passes through the magnetic field can be adopted to make the soft magnetic materiall 15a-33 rising to the position below the transparent film layer returned to the initial state to erase the character recycle the media.

The page media has a levelling layer 15b which adopts the thermal press principle to level the media again.

### Embodiment 2

It describes a recording system adopting different printing modules according to different media. FIG. 21 is a data structural view of an identification code 17 of a page media 15, wherein the identification code is a magnetic bar code or two-dimensional bar code.

The identification code 17 of the media 15 consists of the data information codes of a mark 17a1 and a mark 17b2. The data information code of the mark 17b2 is an area B, which is a third mark representing the material type of the media 15; the data information code of the mark 17a1 is in an area Am, representing that the media 15 belongs to ink jet type.

If the third mark exists, this means the media 15 is the photo paper, and if not, this means the media is common paper.

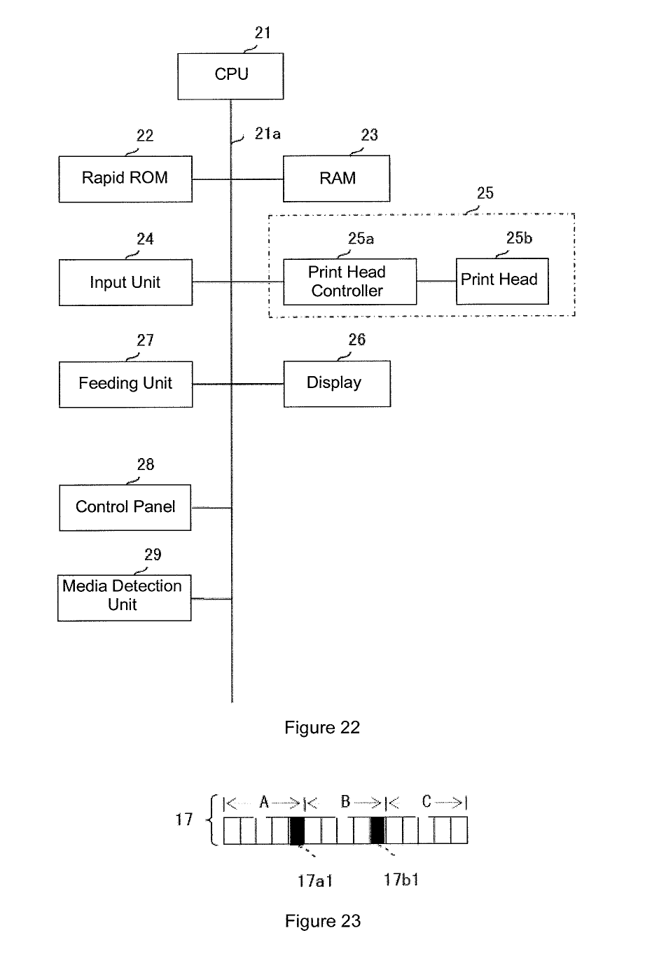

FIG. 22 illustrates the system configuration diagram, a media detection unit 29 may be a magnetic bar code reader or a graphic code detector, the media detection unit 29 and the identification code 17 of the media 15 together form a media information unit 2, and a media writing-in unit 25 adopts an ink jet printing mode.

A rapid ROM22 stores two types of printing software control modules. One is used for printing the photo paper, the ink jet of the print head is fine; and the other is used for printing the corner paper, and the ink jet of the print head is relatively small to save ink and printing time. When the system works, if the media detection unit 2 detects the third mark, this means the media 15 fed into the system is a piece of photo paper, then the system will adopt the photo paper printing mode; otherwise, the system will adopt the common paper printing mode.

### Embodiment 3

It describes a recording system comprising a plurality of recording units. Strictly speaking, the recording page media required to be kept for a long time (3-5 years) is suitable for being printed by the traditional laser means, while the reusable recording page media recording only required to be kept for a short time (1-12 months) is suitable. Therefore, a recording system comprising a plurality of recording units is required.

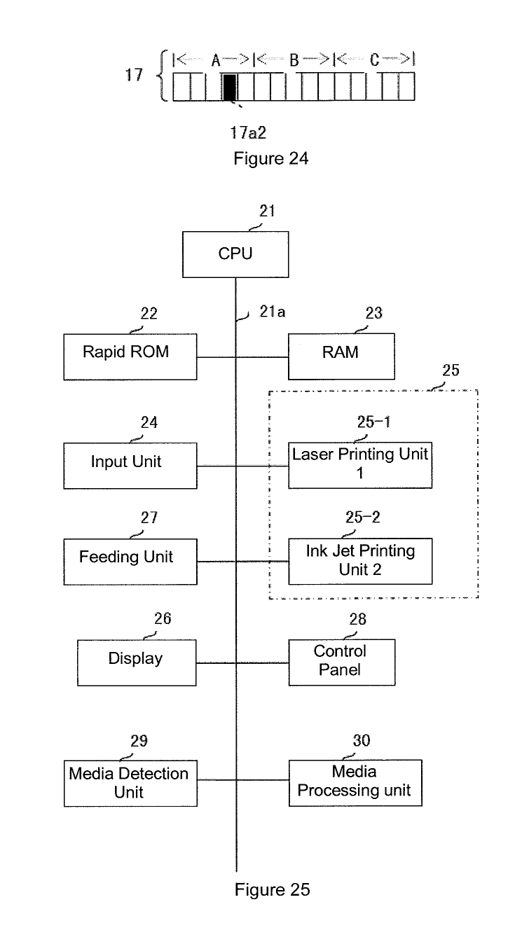

FIGS. 23 and 24 are data structural views of identification codes 17 of two kinds of page media 15, wherein the identification code is a magnetic bar code or two-dimensional bar code.

As shown in FIG. 23, the identification code 17 of the media 15 consists of the data information codes of a mark 17a1 and a mark 17b1 (the second mark).The data information code of the mark 17b1 (the second mark) is in an area B, representing that the media 15 is a reusable recording media; the data information code of the mark 17a1 is in an area A, representing that the media 15 belongs to the ink jet printing type.

As shown in FIG. 24, the identification code 17 of the media 15 comprises the mark 17a2. The data information code of the mark 17a2 is in an area A, which is the fourth mark representing that the media 15 is a recording media belonging to the laser printing type.

FIG. 25 illustrates the system configuration diagram of the embodiment. A printing unit 25 consists of two parts: a laser printing unit 25-1 and an ink jet printing unit 25-2 which is suitable for the reusable media; a media detection unit 29 may be a magnetic bar code reader or a graphic code detector, meanwhile the media detection unit 29 and the identification code 17 of the media 15 together forms a media information unit 2.

A rapid ROM22 stores two types of printing software control modules. One for laser printing is applied to the laser printing unit 25-1, and the other for ink jet printing is applied to the ink jet printing unit 25-2.

The control units work according to the detection results of the media detection unit 29. If the fourth mark is detected, the media 15 is fed into the laser printing unit 25-1 to be printed; otherwise, the media 15 is fed into the ink jet printing unit 25-2 to be printed in a recyclable way or common way according to the situation of the media.

### Embodiment 4

It describes a recording system which detects the media state information by detecting the feeding route of the page media.

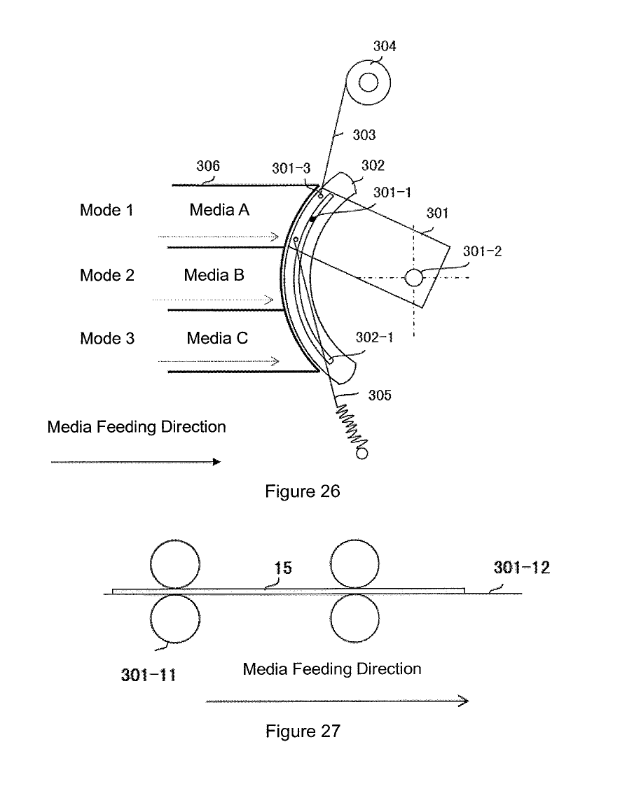

FIG. 26 is a lateral perspective view of a systematic drive mechanism of the recoding system that performs multi-mode processing according to the media feeding route. The mark 301 represents a mobile drive unit, the mark 301-1 represents a guide shaft of the mobile drive unit, and by means of the guide shaft and the guide rail 302-1, the mobile drive unit moves vertically by taking the fixed shaft 302-2 as the circle centre. The mark 302 represents a guide ring with the guide rail 302-1, The mobile drive unit is connected with a control wheel 304 via the steel rope 303, the control wheel controls the tightening and release of the steel rope 303 via the system's control unit 1 to control the displacement mobile drive unit 301, so the mobile drive unit accurately moves to different transfer channels 306; the feeding route has three modes: in the first mode, the channel is loaded with the media A; in the second mode, the channel is loaded with the media B; and in the third mode, the channel is loaded with the media C. A small hole 301-3 is a fixed position of the steel rope in the mobile drive unit, and the mark 305 represents a fixed ring of the mobile drive unit 301.

FIG. 27 is a schematic view of the internal structure of a mobile drive unit 301. The mark 301-11 represents drive rollers between which the media 15 passes through; the mark 301-12 represents a media feeding route.

The recording system adopts different processing means according to the location information about the mobile drive unit 301, which means the control unit 1 judges the state information of the recording media according to the channel information.

The invention is further described in details, which comprises, but is not limited to above embodiments. For those skilled persons in this field, in the concept of this invention, all modifications, revisions and substitutions shall be within the protection scope of this invention.

1. An information recording system, comprising:
a recording unit for recording corresponding contents on the recording media;
a media information unit for acquiring and/or correcting the related media state information of the recording media;
a feeding unit for passing on the recording media to the media information unit and the recording unit in turn; and,
a control unit for controlling the work of all components of the information recording system respectively.

2. The information recording system according to claim 1, characterized in that the recording unit comprises at least two different recording processing modules, wherein the control unit chooses one of the two modules to process corresponding recording media.

3. The information recording system according to claim 1, also comprising a media processing unit for processing the recording media correspondingly according to the media state information acquired by the media information unit, wherein the feeding unit feeds or passes on the recording media to the media information unit, the media processing unit and the recording unit in turn in turn.

4. The information recording system according to claim 3, characterized in that the media processing unit comprises an erasing device for erasing the contents existing on the recording media.

5. The information recording system according to claim 3, characterized in that the media processing unit comprises a levelling device for levelling the recording media.

6. The information recording system according to claim 4, characterized in that the erasing device may be a chemical, magnetic or thermo-sensitive erasing device.

7. The information recording system according to any one of claims 1 to 6, characterized in that the media state information comprises a first mark or first state information for marking whether or not the recording media is used, and/or a second mark or second state information for marking whether or not the recording media is recyclable, and/or a third mark or third state information for marking the types of the recording media, and/or a fourth mark or fourth state information for marking the recording means of the recording media.

8. The information recording system according to any one of claims 1 to 6, characterized in that the media information unit may be a magnetic read-write device, a graphic code detector, or both of the two.

9. The information recording system according to any one of claims 1 to 6, characterized in that the media information unit comprises a route detector for detecting the source of the recording media, wherein the recording refers to printing or duplicating.

10. An information recording method, comprising:
a step of feeding the media: the recording media is input from the feeding unit;
a step of processing the media information: the media information unit reads and/or writes the corresponding state information of the recording media;
a recording step: the printing unit under the control the control unit records corresponding contents on the recording media according to the media state information.

11. The information recording method according to claim 10, characterized in that between the step of processing the media information and a step of recording the method also comprise:
a step of processing the media: according to the media state information acquired by the media information unit, the media processing unit correspondingly processes recording media.
